(19) United States
(12) Patent Application Publication
(10) Pub. No.: US 2013/0008227 A1
(43) Pub. Date: Jan. 10, 2013

(54) SHOCK AND IMPACT TESTING DEVICE AND METHOD

(75) Inventors: DI-GANG ZHAI, Shenzhen City (CN); GUANG-MING WEN, Shenzhen City (CN); YUAN-WANG LIU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/327,421

(22) Filed: Dec. 15, 2011

(30) Foreign Application Priority Data
Jul. 8, 2011 (CN) 201110190594.3

(51) Int. Cl. G01N 3/30

(52) U.S. Cl. 73/12.07

(57) ABSTRACT

A shock and impact testing device includes a shock and impact module and a control module. The shock and impact module includes a platform, an air cylinder having a rod, an impact head positioned on the platform aligning with the rod, and a lifting structure connected to the platform to drive the platform to rise and then release the platform to allow the platform to fall down freely until the impact head hits the rod. The control module calculates a pressure of the air cylinder and a height difference between the impact head and the rod, and controls the lifting structure to drive the platform to rise to a height difference between the impact head and the rod meets the calculated height difference and adjusting a pressure of the air cylinder to meet the calculated pressure.

### BACKGROUND

1. Technical Field

The disclosure generally relates to shock and impact testing devices and methods, and particularly to a shock and impact testing device and method for electronic devices such as mobile phones.

2. Description of Related Art

During the manufacture of electronic devices such as mobile phones, shock and impact testing is commonly executed to verify assembly qualities of the electronic devices. A typical shock and impact testing device includes a platform, an impact head positioned on one side of the platform, an air cylinder aligned with the impact head and a lifting structure. The platform is configured for supporting the electronic device. The lifting structure drives the platform to rise to a height and then release the platform. The platform falls downwards until the impact head hits the air cylinder to simulate a shock and impact situation to test the electronic device.

During testing, a suitable height difference between the impact head and the air cylinder, and the pressure of the air cylinder is needed to obtain corresponding impact parameters such as a rebounding acceleration of the platform and a staying time of the impact head for the electronic devices.

Operators commonly select a height difference and a pressure according to experience, then drive the shock and impact testing device to execute the testing steps to check whether predetermined testing parameters could be obtained, and repeat the aforesaid steps until predetermined testing parameters is obtained. Thus, much time may be wasted during test and the lifetime of the shock and impact testing device may be shortened because of the repeated impact process.

Therefore, there is room for improvement within the art.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the disclosure.

FIG. 1 is a schematic view of a shock and impact module of a shock and impact device, according to an exemplary embodiment of the disclosure.

FIG. 2 is a block diagram of a control module of a shock and impact device, according to an exemplary embodiment of the disclosure.

### DETAILED DESCRIPTION

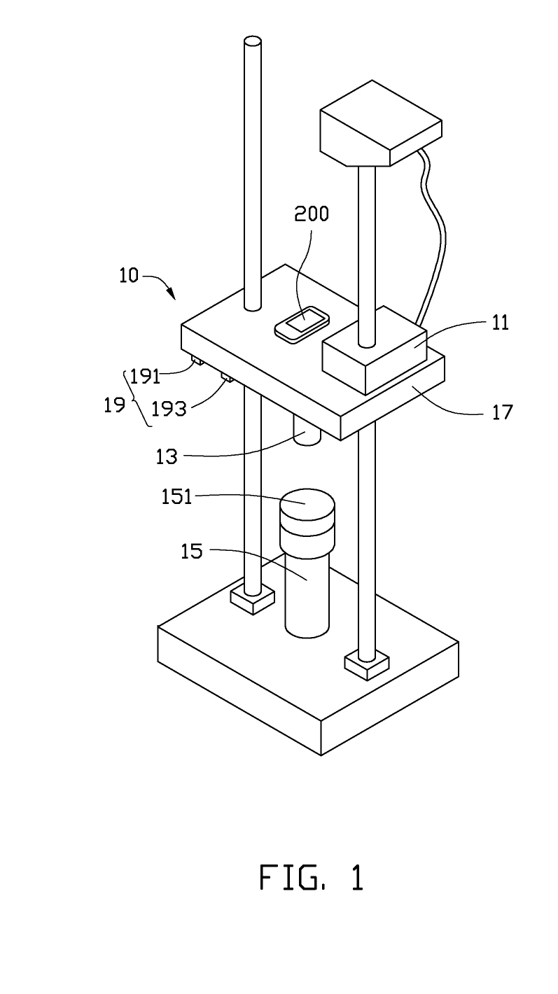

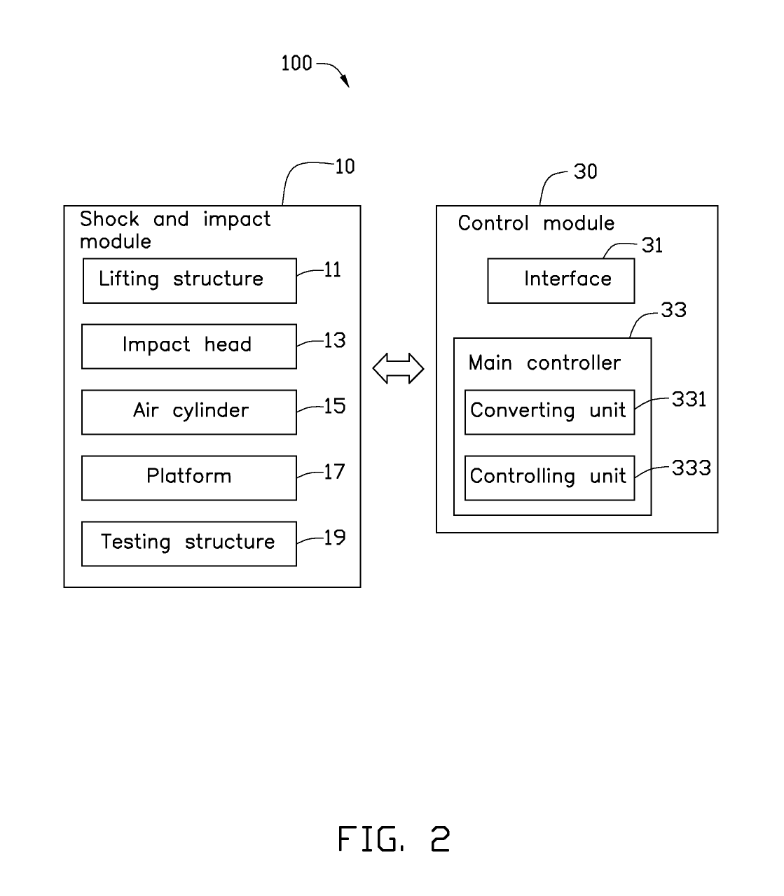

Referring to FIGS. 1 and 2, an exemplary embodiment of shock and impact testing device 100 includes a shock and impact module 10 and a control module 30 electrically connected to the shock and impact module 10. The control module 30 receives impact parameters, computing the impact parameters to get testing parameters, and drives the shock and impact module 10 to execute shock and impact testing for an electronic device 200 according to the testing parameters.

The shock and impact module 10 includes a lifting structure 11 (schematically shown), an impact head 13, an air cylinder 15, a platform 17 secured to the lifting structure 11, and a testing structure 19. The impact head 13 is position on the one side of the platform 17 facing the cylinder 15. The cylinder 15 has a rod 151 aligned with the impact head 13. In the exemplary embodiment, the cylinder 15 is a piston-type air cylinder. The platform 17 is configured for supporting the electronic device 200.

The lifting structure 11 is configured for driving the platform 17 to rise to an appropriate height, and thus a height difference H, which is one of the testing parameters, between the impact head 13 and the rod 151 can meet an appropriate height difference. When the lifting structure 14 drives the platform 17 to rise to the appropriate height, and then releases the platform 17, the platform 17 and the electronic device 200 falls freely until the impact head 13 hits the rod 151. The impact head 13 stays on the rod 151 for a period of time, which is one of the impact parameters and is defined as staying time D, and then rebounds back from the rod 151 with the platform 17 and the electronic device 200. The testing structure 19 is configured for testing a rebounding acceleration A, which is another impact parameter, of the platform 17 when the impact head 13 rebounds back from the rod 151 and the staying time D. The testing structure 19 includes a first sensor 191 and a second sensor 193, both of which are mounted on the platform 17. The first sensor 191 is configured to measure the rebounding acceleration A of the platform 17 and send the rebounding acceleration A to a display (not shown), and the second sensor 193 is configured to measure the staying time D and sends the staying time D to the display.

The control module 30 includes an interface 31 and a main controller 33. The interface 31 is configured for inputting the impact parameters including the rebounding acceleration A and the staying time D.

The main controller 33 includes a converting unit 331 and a controlling unit 333 connecting to the converting unit 331. The converting unit 331 is configured for receiving the impact parameters, and computing corresponding testing parameters to be set in the shock and impact module 10 such as the height difference H between the impact head 13 and the rod 151, and the pressure P of the cylinder 15, which is another testing parameter, according to the impact parameters. The controlling unit 333 is configured for controlling the lifting structure 14 to drive the platform 17 to move to an appropriate height and adjusting the pressure P of the cylinder 15 according to the testing parameters.

A method of computing the height difference H between the impact head 13 and the rod 151 by the converting unit 331 may be illuminated as follow:

A first formula: ΔV=V1−(−V2) can be obtained, wherein V1 is a transient speed of the impact head 13 when the impact head 13 hits the rod 151; V2 is a transient speed of the impact head 13 when the impact head 13 rebounds back from the rod 151; the ΔV is the difference between V1 and V2.

Since V1 and V2 have opposite directions, a second formula: ΔV=|V1|+|V2| can be obtained, according to the first formula.

A third formula:

$$\frac{1}{2} MV {1}^{2} = MgH$$

can be obtained, according to the law of conservation of energy, wherein M is a total weight of the impact head 13, the platform 17 and the electronic device 200, and is a fixed value; g is the acceleration of free fall.

A fourth formula:

$$e = \frac{V 2}{V 1}$$

combines the second and the third formulas can obtain a fifth formula: ΔV=(1+e)×\sqrt{2gH}, wherein e is a restitution coefficient, and is a fixed value.

In addition, a sixth formula: ΔV=0.9×AD×10⁻³ can be obtained, according to the international electro technical commission (IEC).

Thus, a seventh formula: 0.9×AD×10⁻³=(1+e)×\sqrt{2gH} can be obtained through combining the fifth and sixth formulas.

When a pressure P of the cylinder 15 and a height difference H between the impact head 13 and the rod 151 is determined, the value of the rebounding acceleration A and the staying time D can be derived through the testing structure 19, the value of restitution coefficient e can be calculated by inputting the rebounding acceleration A, staying time D and height differences H to the seventh formula: 0.9×AD×10⁻³=(1+e)×\sqrt{2gH}.

Therefore, since the restitution coefficient e and the acceleration of free fall g are fixed values, when the interface 31 receives a value of the rebounding acceleration A and a value of the staying time D, the converting unit 331 can compute the height difference H according to the seventh formula: 0.9×AD×10⁻³=(1+e)×\sqrt{2gH}.

A method of computing the pressure P of the rod 151 by the converting unit 331 may be illuminated as follow:

A eighth formula: F=M×A and a ninth formula: F′=P×S can be obtained, wherein F is a force exerted by the rod 151 on the impact head 13; F′ is another force exerted by the impact head 13 on the rod 151; S is an end surface area of the rod 151, and is a fixed value. Since the force F is equal in magnitude and opposite in direction to the force F′, a tenth formula:

$$P = \frac{A \times M}{S}$$

can be obtained through combining the eighth formula and the ninth formula.

When a pressure P of the cylinder 15 and a height difference H between the impact head 13 and the rod 151 is determined, the value of the rebounding acceleration A and the staying time D can be derived through the testing structure 19, the value of end surface area S of the rod 151 can be calculated by inputting the values of the rebounding acceleration A and the determined pressure P of the cylinder 15 to the tenth formula:

$$P = \frac{A \times M}{S} .$$

Therefore, since the total weight M and the end surface area S are fixed values, when the interface 31 receives a value of the rebounding acceleration A, the converting unit 331 can compute the pressure P of the cylinder 15 according to the tenth formula:

$$P = \frac{A \times M}{S} .$$

When the impact parameters (e.g. a rebounding acceleration A=60 g and a staying time D=11 ms) are input into the converting unit 331 through the interface 31, the converting unit 331 calculates a corresponding testing parameter of the shock and impact module 10 (i.e. a pressure of the cylinder 15, and a height difference between the impact head 13 and the rod 151) according to the seventh formula: 0.9×AD×10⁻³=(1+e)×\sqrt{2gH} and the tenth formula:

$$P = \frac{A \times M}{S} .$$

Thus, the suitable parameter can be obtained without executing the crash process for many times, which can save the testing time and decrease crash times of the shock and impact module 10.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A shock and impact testing device comprising:
a shock and impact module, the shock and impact module comprising:
a platform;
an air cylinder having a rod;
an impact head positioned on the platform aligning with the rod; and
a lifting structure connected to the platform to drive the platform to rise and then release the platform to allow the platform to fall down freely until the impact head hits the rod; and
a control module, the control module comprising:
an interface configured for inputting a rebounding acceleration of the platform and a staying time the impact head staying on the rod;
a converting unit calculating a pressure of the air cylinder and a height difference between the impact head and the rod according to the rebounding acceleration and the staying time; and
a controlling unit controlling the lifting structure to drive the platform to rise to a height difference between the impact head and the rod meets the calculated height difference and adjusting a pressure of the air cylinder to meet the calculated pressure.

2. The shock and impact testing device of claim 1, wherein the shock and impact module further comprises a testing structure configured for testing the staying time when the impact head stays on the rod and the rebounding acceleration when the impact head rebounds back from the rod.

3. The shock and impact testing device of claim 1, wherein the height difference between the impact head and the rod is calculated according to formula: 0.9×AD×10⁻³=(1+e)×\sqrt{2gH}, wherein H is the height difference, e is a restitution coefficient, g is the acceleration of free fall, A is the rebounding acceleration, D is the amount of time the impact head stays on the rod.

4. The shock and impact testing device of claim 1, wherein the height difference between the impact head and the rod is calculated according to formula:
$$P = \frac{A \times M}{S} ,$$
wherein P is the pressure of the air cylinder, A is the rebounding acceleration, S is a end surface area of the rod, and M is a total weight of the impact head and the platform.

5. The shock and impact testing device of claim 1, wherein the air cylinder is a piston-type air cylinder.

6. A shock and impact testing method comprising:
providing a shock and impact module, the shock and impact module comprising:
a platform;
an air cylinder having a rod;
an impact head positioned on the platform aligning with the rod; and
a lifting structure connected to the platform to drive the platform to rise and then release the platform to allow the platform to fall down freely until the impact head hits the rod;
inputting a rebounding acceleration of the platform and a staying time the impact head staying on the rod;
calculating a pressure of the air cylinder and a height difference between the impact head and the rod according to the rebounding acceleration and the staying time;
controlling the lifting structure to drive the platform to rise to a height difference between the impact head and the rod meets the calculated height difference and adjusting a pressure of the air cylinder to meet the calculated pressure.

7. The shock and impact testing method of claim 6, wherein the height difference between the impact head and the rod is calculated according to formula: 0.9×AD×10⁻³=(1+e)×\sqrt{2gH}, wherein H is the height difference, e is a restitution coefficient, g is the acceleration of free fall, A is the rebounding acceleration, D is the amount of time the impact head stays on the rod.

8. The shock and impact testing method of claim 6, wherein the height difference between the impact head and the rod is calculated according to formula:
$$P = \frac{A \times M}{S} ,$$
wherein P is the pressure of the air cylinder, A is the rebounding acceleration, S is a end surface area of the rod, and M is a total weight of the impact head and the platform.

9. A control module in electronic communication with a shock and impact module, wherein the shock and impact module comprises a platform, an air cylinder having a rod, an impact head positioned on the platform aligning with the rod; and a lifting structure connected to the platform to drive the platform to rise and then release the platform to allow the platform to fall down freely until the impact head hits the rod; remote monitoring apparatus, wherein the control module comprising:
an interface configured for inputting a rebounding acceleration of the platform and a staying time the impact head stays on the rod;
a converting unit calculating a pressure of the air cylinder and a height difference between the impact head and the rod according to the rebounding acceleration and the staying time; and
a controlling unit controlling the lifting structure to drive the platform to rise to a height difference between the impact head and the rod meets the calculated height difference and adjusting a pressure of the air cylinder to meet the calculated pressure.

10. The control module of claim 9, wherein the height difference between the impact head and the rod is calculated according to formula: 0.9×AD×10⁻³=(1+e)×\sqrt{2gH}, wherein H is the height difference, e is a restitution coefficient, g is the acceleration of free fall, A is the rebounding acceleration, D is the amount of time the impact head stays on the rod.

11. The control module of claim 9, wherein the height difference between the impact head and the rod is calculated according to formula:
$$P = \frac{A \times M}{S} ,$$
wherein P is the pressure of the air cylinder, A is the rebounding acceleration, S is a end surface area of the rod, and M is a total weight of the impact head and the platform.
